(19) United States
(12) Patent Application Publication
(10) Pub. No.: US 2006/0038529 A1
(43) Pub. Date: Feb. 23, 2006

(54) Rotation units and control systems having rotational direction control and methods of controlling the same

(76) Inventor: Hyeong-wook Park, Gyeonggi (KR)

Correspondence Address: Robert W. Glatz;Myers Bigel Sibley & Sajovec, Post Office Box 37428, Raleigh, NC, 27627, US

(21) Appl. No.: 11/053,071

(22) Filed: Feb. 8, 2005

(30) Foreign Application Priority Data
Aug. 21, 2004 (KR) 10-2004-66167

(51) Int. Cl. H02P 5/28

(52) U.S. Cl. 318/798

(57) ABSTRACT

Rotation control systems for a rotation unit of an apparatus for manufacturing semiconductor devices include a control circuit configured to control an electrical power connection to the rotation unit to rotate the rotation unit in a desired direction responsive to a sensed rotational direction of the rotation unit. Rotation units including the rotation control system of the present invention may further include a rotation unit, a rotational direction sensing unit that senses an actual direction of rotation of the rotation unit and generates an output signal based on the sensing result and a rotational direction determining unit that determines the actual direction of rotation of the rotation unit in response to the output signal of the rotational direction sensing unit.

### CROSS-REFERENCE TO RELATED APPLICATION

This application is related to and claims priority from Korean Patent Application No. 2004-66167, filed on Aug. 21, 2004, the disclosure of which is hereby incorporated herein by reference in its entirety.

### BACKGROUND OF THE INVENTION

The present invention relates to apparatus for manufacturing semiconductor devices, and more particularly, to a rotation system for an apparatus for manufacturing semiconductor devices.

Semiconductor/Integrated circuit manufacturing apparatus typically include a plurality of rotation systems. For example, a reaction chamber, in which depositions and etchings of layers and structures are performed on a semiconductor wafer, generally requires an exhaust pump to maintain the inside of the reaction chamber under an appropriate pressure. The pump may suck gases from the reaction chamber based on rotation of an internal rotation unit and exhaust the gases outside the chamber. A typical pump utilizes a motor to drive the internal rotation unit.

FIG. 1 is a cross-sectional view of a conventional rotation system for an apparatus of manufacturing semiconductor devices, shown as a pump 100 including a motor 140. FIG. 2 illustrates the structure of the pump 100 seen from a direction “A” of FIG. 1. As shown in FIGS. 1 and 2, the pump 100 includes a body 110 that surrounds an inner plenum. The inner plenum includes a first plenum 131 and a second plenum 132, which are insulated from each other by a pulley 120. In the first plenum 131, the motor 140 and a first rotation axis (shaft) 151 are located in a lower portion, and a second rotation axis (shaft) 152 is located in an upper portion. The first and second rotation axes 151 and 152 located in the first plenum 131 extend into the second plenum 132. A rotor 160 is inserted onto the first and second rotation axes 151 and 152 on an end thereof extending into the second plenum 132.

For the illustrated pump 100, a three-phase power source is supplied to the motor 140 to rotate the first rotation axis 151. The second rotation axis 152 is coupled to and synchronized with the first rotation axis 151 by the pulley 120 and also rotates when the first rotation axis 151 rotates. As the first and second rotation axes 151 and 152 rotate, the rotor 160 located in the second plenum 132 is rotated. When the rotor 160 rotates, the pump 100 sucks gases from a reaction chamber (not shown) into the second plenum 132.

In order to operate the above-described conventional rotation system, a three-phase power supply should generally be supplied to the motor 140. As is well known, a direction of rotation of the rotation system may be reversed by transposing connection of the three-phase power lines of the three-phase power supply to reverse a direction in which a three-phase current is supplied. However, when the rotation system is repaired or replaced, the three-phase power lines may be unintentionally transposed, thus causing an undesired reversal of a rotational direction of the pump 100. Specifically, while a power line between a device, such as a switchgear panel, and the rotation system is being manually repositioned, the power line may be mistakenly transposed. Alternatively, power lines of a rotation system may be transposed while connecting the power lines to reset the apparatus. The transposition of the power lines generally leads to a reversal of a rotational direction. Thus, once the rotational direction is reversed, a pump may exhaust gases into the reaction chamber instead of sucking gases from the reaction chamber.

For this reason, after a three-phase power is supplied to the rotation system, a possibly difficult process of confirming an actual direction of rotation of the rotation system visually may be needed. If the actual direction is the opposite of a desired direction, the three-phase power lines should be manually repositioned, thus resulting in a non-productive expenditure of human power, cost, and time.

### SUMMARY OF THE INVENTION

Embodiments of the present invention provide rotation control systems for a rotation unit of an apparatus for manufacturing semiconductor devices. The system includes a control circuit configured to control an electrical power connection to the rotation unit to rotate the rotation unit in a desired direction responsive to a sensed rotational direction of the rotation unit. The electrical power connection may be a three-phase electrical power connection having first, second and third power lines coupled to first, second and third power supply lines of the rotation unit and the control circuit may be a switch circuit having a first state in which the first power line is connected to the first power supply line and the second power line is connected to the second power supply line and a second state in which the first power line is connected to the second power supply line and the second power line is connected to the first power supply line.

In further embodiments of the present invention, the switch circuit includes a first switch having an input coupled to the first power line, an output coupled to the first power supply line and an output coupled to the second power supply line. A second switch has an input coupled to the second power line, an output coupled to the first power supply line and an output coupled to the second power supply line. The switch circuit may include a first delay coupled between the output of the first switch coupled to the second power supply line and the second power supply line and a second delay coupled between the output of the first switch coupled to the second power supply line and the second power supply line. The first delay and the second delay may be to interrupt power supply to the rotation unit until the rotation unit stops rotating.

In other embodiments of the present invention, the sensed rotational direction is detected by a current sensing unit including a plurality of current sensors configured to sense a current associated with respective power lines associated with the electrical power connection. The control circuit is configured to detect a sequence of output signals from respective ones of the current sensors to determine the sensed rotational direction of the rotation unit.

In further embodiments of the present invention, the rotation unit is a pump having an inlet and an outlet. The sensed rotational direction is detected by a first pressure sensor that detects a pressure at the inlet and a second pressure sensor that detects a pressure at the outlet. The control circuit is configured to detect an amplitude difference between the first and second pressure sensor to determine the sensed rotational direction of the rotation unit. In yet other embodiments of the present invention, rotation systems for an apparatus of manufacturing semiconductor devices are provided including the rotation control system of the present invention. The rotation system further includes the rotation unit, a rotational direction sensing unit configured to generate a sense output signal based on a current rotational direction of the rotation unit and a rotational direction determining unit configured to generate the sense rotational direction responsive to the sense output signal of the rotational direction sensing unit.

In yet further embodiments of the present invention, methods of controlling a direction of rotation for a rotation unit of an apparatus for manufacturing semiconductor devices using a three-phase power supply having a plurality of power lines to power the rotation unit are provided. A current rotational direction of the rotation unit is automatically detected. It is automatically determined whether the current rotational direction is a desired direction. Connections of the plurality of power lines to respective corresponding power supply lines of the rotation unit are automatically switched responsive to determining that the current rotational direction is not the desired direction.

In other embodiments of the present invention, rotation systems for an apparatus of manufacturing semiconductor devices include a rotation unit and a rotational direction sensing unit that senses an actual direction of rotation of the rotation unit and generates an output signal based on the sensing result. A rotational direction determining unit determines the actual direction of rotation of the rotation unit in response to the output signal of the rotational direction sensing unit. A power controlling unit controls a power connection supplied to the rotation unit such that the rotation unit rotates in a desired direction based on the determined actual direction of rotation. The rotation unit may include a motor, of which a rotational direction is reversed by transposing three-phase power lines, or a pump including a rotor that is rotated by the motor.

In further embodiments of the present invention, the rotational direction sensing unit includes at least three current sensors, which sense currents flowing through the respective three-phase power lines. The rotational direction determining unit may determine a direction of rotation of the rotation unit depending on a sequence of input of three output signals output from the at least three current sensors and generate one of two output signals according to rotational directions, based on the determined actual direction of rotation.

In yet other embodiments of the present invention, the rotational direction sensing unit includes at least two pressure sensors installed at an inlet and an outlet of the pump. The at least two pressure sensors may measure pressures at the inlet and outlet, respectively, and generate output signals in proportion to the measured pressures. The rotational direction determining unit may determine the rotational direction of the rotation unit by comparing the output signals of the two pressure sensors and generate one of two output signals according to rotational directions, based on the determined actual direction of rotation.

In further embodiments of the present invention, the power controlling unit includes a first switch circuit that selectively connects a first power line of the three-phase power lines to any one of a first power supply line and a second power supply line, through which power is supplied to the rotor that rotates by the motor. A second switch circuit selectively connects a second power line of the three-phase power lines to any one of the first power supply line and the second power supply line, through which power is supplied to the rotor that rotates by the motor. The first switch circuit and the second switch circuit may operate in response to the output signal of the rotational direction determining unit.

The first switch circuit may include a switch connected to the first power line and a first contact and a second contact, which are connected to the first and second power supply lines, respectively. The second switch circuit may include a switch connected to the second power line and a third contact and a fourth contact, which are connected to the second and first power supply lines, respectively. The first switch circuit may include a first fuse and a first delay located between the second contact and the first contact and the second switch circuit may include a second fuse and a second delay located between the fourth contact and the first contact. An output signal amplifying unit may be provided that amplifies the output signal of the rotational direction sensing unit and outputs the amplified output signal to the rotational direction determining unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view of a conventional rotation system for an apparatus of manufacturing semiconductor devices, which is a pump including a motor;

FIG. 2 is an end view of the structure of the pump of FIG. 1 seen from a direction “A” of FIG. 1;

FIG. 3 is a block diagram of a rotation system of an apparatus of manufacturing semiconductor devices, according to some embodiments of the present invention;

FIG. 4 is a cross-sectional view of a rotation system and a rotational direction sensing unit according to some embodiments of the present invention;

FIG. 5 is an end view of the rotation system of FIG. 4 seen from a direction “A” of FIG. 4;

FIG. 6 is a cross-sectional view of a rotation system and a rotational direction sensing unit according to other embodiments of the present invention;

FIG. 7A is a circuit diagram of an output signal amplifying unit according to some embodiments of the present invention;

FIG. 7B is a circuit diagram of an output signal amplifying unit according to other embodiments of the present invention;

FIG. 8A is a schematic diagram illustrating the operation of a rotational direction determining unit according to some embodiments of the present invention;

FIG. 8B is a schematic diagram illustrating the operation of a rotational direction determining unit according to other embodiments of the present invention; and

FIG. 9 is a circuit diagram of a power controlling unit according to some embodiments of the present invention.

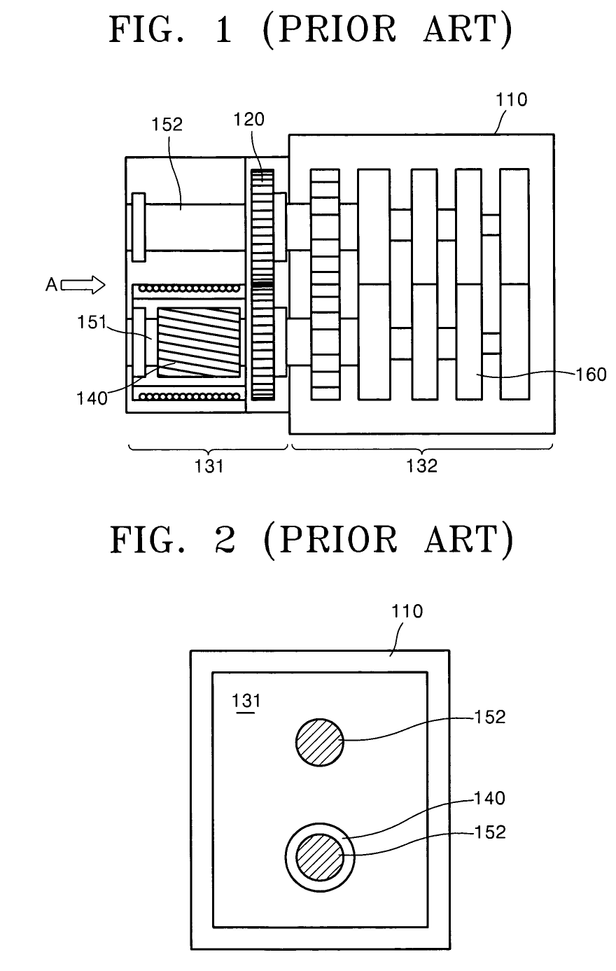

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

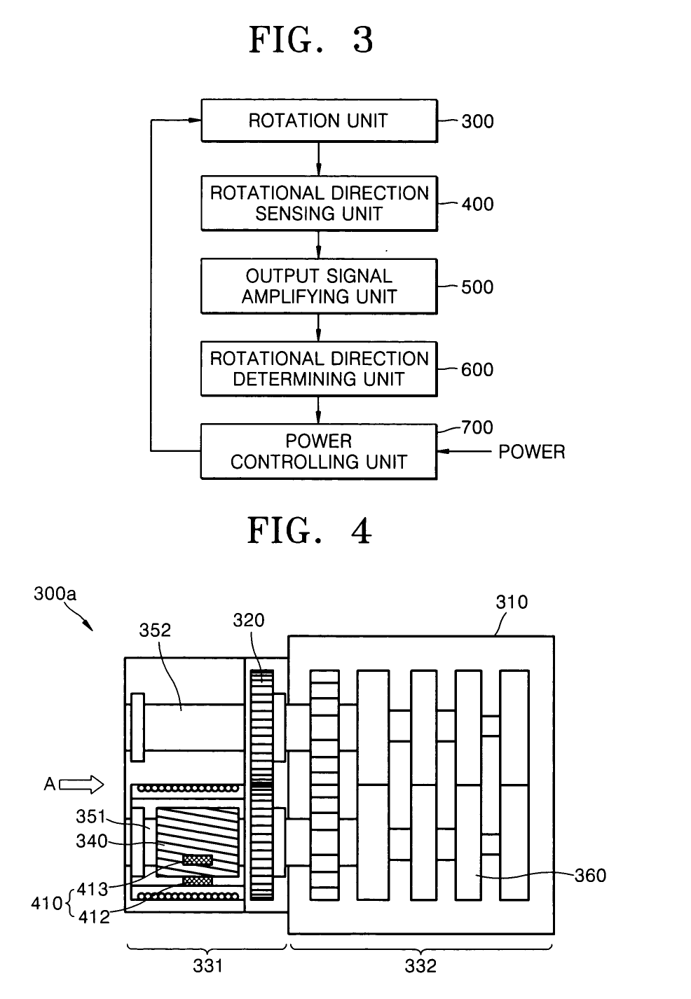

Embodiments of the present invention will now be described with reference to the figures. FIG. 3 is a block diagram of a rotation system of an apparatus for manufacturing semiconductor devices according to some embodiments of the present invention. As shown schematically in the embodiments of FIG. 3, the rotation system includes a rotation unit 300, a rotational direction sensing unit 400, an output signal amplifying unit 500, a rotational direction determining unit 600, and a control circuit 700, shown as a power controlling unit in FIG. 3. The control circuit 700 may be configured to control an electrical power connection to the rotation unit to rotate the rotation unit in a desired direction responsive to a sensed rotational direction of the rotation unit as will be further described herein.

The rotation unit 300 includes a rotation body, which may be composed of a permanent magnet, a coil, an electromagnet, a stator, a rotator, and a bearing. The rotation body rotates responsive to a power source, such as electric signals. Examples of the rotation unit 300 include a motor and a pump including a motor. In the case of the motor or the pump including a motor, a three-phase power may be supplied thereto, and a rotational direction of the unit may be reversed by transposing three-phase power lines.

The rotational direction sensing unit 400 in the illustrated embodiments senses an actual rotational direction of the rotation unit 300 and generates an output signal in response to the rotational direction. The rotational direction sensing unit 400 may be, for example, a current sensing unit or a pressure sensing unit.

The output signal amplifying unit 500 in the illustrated embodiments amplifies the output signal of the rotational direction sensing unit 400 and outputs an amplified signal. The output signal amplifying unit 500 may reduce and/or minimize the influences of external signals, such as noise signals, on the output signal of the rotational direction sensing unit 400. The rotational direction determining unit 600 determines the rotational direction of the rotation unit 300 in response to the output signal of the output signal amplifying unit 500 and outputs the determination result.

The power controlling unit 700 in the illustrated embodiments controls the amount of power supplied to the rotation unit 300. Specifically, the power controlling unit 700 may be configured to control the power supply based on the determination result output from the rotational direction determining unit 600, such that the rotation unit 300 always has a normal directional rotation.

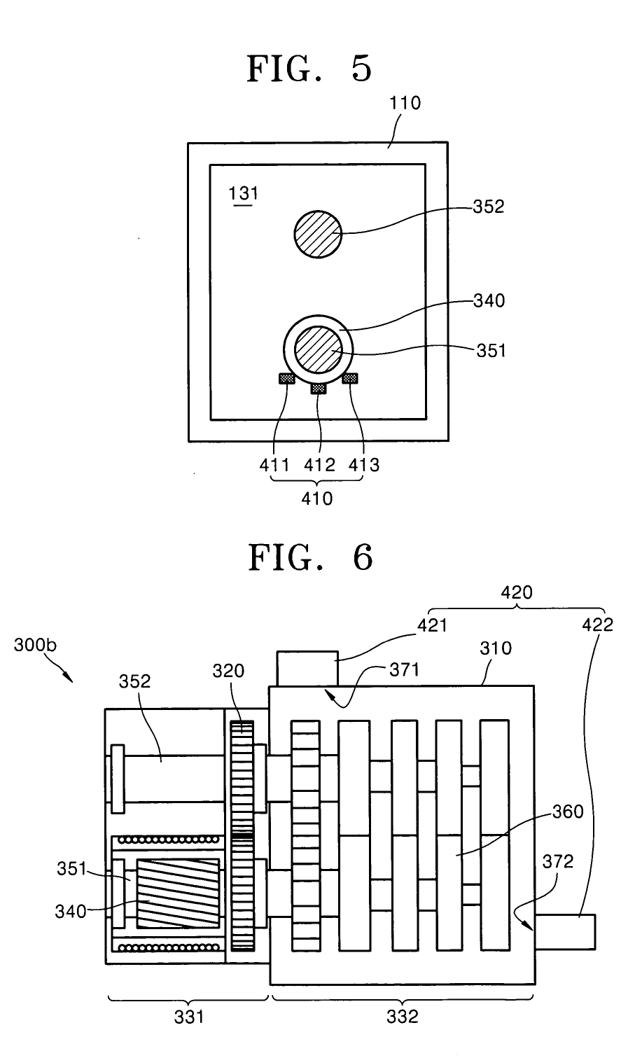

FIG. 4 is a cross-sectional view of a rotation unit and a rotational direction sensing unit according to some embodiments of the present invention. The embodiments of FIG. 4 are shown as having a pump 300a. The pump 300a includes a motor 340 and a current sensing unit 410 attached to the motor 340. FIG. 5 is an end view that illustrates the structure of the pump 300a seen from a direction “A” of FIG. 4.

Referring to FIGS. 4 and 5, the pump 300a includes a body 310 that surrounds an inner plenum (cavity). The inner plenum includes a first plenum 331 and a second plenum 332, which are isolated from each other by a pulley 320. In the first plenum 331, the motor 340 and a first rotation axis (shaft) 351 are located in a lower portion, and a second rotation axis (shaft) 352 is located in an upper portion. The first rotation axis 351 functions as a rotation axis for the motor 340. The first and second rotation axes 351 and 352 located in the first plenum 331 extend into the second plenum 332. A rotor 360 is inserted onto the first and second rotation axes 351 and 352 on an end thereof that extends into the second plenum 332.

When three-phase power is supplied to the pump 300a, the first rotation axis 351 rotates. Te second rotation axis 352 is coupled to and synchronized with the first rotation axis 351 by the pulley 320 and also rotates when the first rotation axis 351 rotates. As the first and second rotation axes 351 and 352 rotate, the rotor 360 located in the second plenum 332 is rotated. When the rotor 360 rotates, the pump 300a sucks gases from a reaction chamber (not shown) into the second plenum 332.

The current sensor 410 is mounted on the motor 340 and, in some embodiments, includes at least three current sensors, namely, a first current sensor 411, a second current sensor 412, and a third current sensor 413. The first current sensor 41 1 senses a current flowing through any selected one of three-phase power lines, the second current sensor 412 senses a current flowing through another one thereof, and the third current sensor 413 senses a current flowing through still another one thereof. Although the current sensor 410 attached to the motor 340 is illustrated in FIG. 5, the first, second, and third current sensors 411, 412, and 413 may, in other embodiments, be respectively located adjacent to the three-phase power lines. Also, in yet other embodiments, a plurality of current sensors are located adjacent each of the three-phase power lines. In other words, a plurality of first current sensors 411 may be located adjacent to any one of three-phase power lines, a plurality of second current sensors 412 may be located adjacent to another one thereof, and a plurality of third current sensors 413 may be located adjacent to still another one thereof.

FIG. 6 is a cross-sectional view of a rotation unit and a rotational direction sensing unit according to other embodiments of the present invention. In the embodiments of FIG. 6, the rotation unit is a pump 300b and the rotational sensing unit is a pressure sensing unit 420. In FIG. 6, the same reference numerals are used to denote elements that are the same as corresponding elements shown in FIG. 4. Thus, a further description thereof need not be presented herein.

Referring to FIG. 6, the pressure sensing unit 420 is used as a rotational direction sensing unit for the pump 300b. The pressure sensing unit 420 includes a first pressure sensor 421 and a second pressure sensor 422. The first pressure sensor 421 is installed at an inlet 371 of the pump 300b, and the second pressure sensor 422 is installed at an outlet 372 thereof The first pressure sensor 421 measures pressure at the inlet 371 and generates an output signal in proportion to the measured pressure. Similarly, the second pressure sensor 422 measures pressure at the outlet 372 and generates an output signal in proportion to the measured pressure.

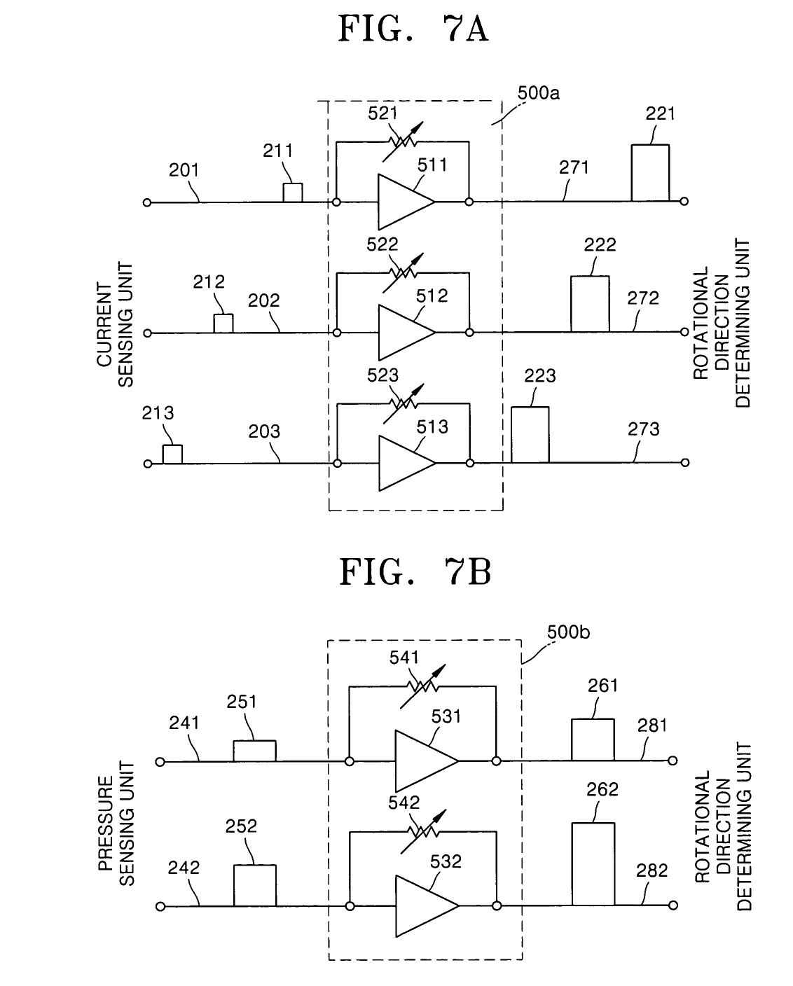

FIG. 7A is a circuit diagram of an output signal amplifying unit 500a according to some embodiments of the present invention. As shown in FIG. 7A, the output signal amplifying unit 500a of the illustrated embodiments can be used when the current sensor 410 is used as the rotational direction sensing unit 400. The illustrated output signal amplifying unit 500a includes a first amplifier 511, a second amplifier 512, and a third amplifier 513. An input terminal of the first amplifier 511 is connected to a first line 201, which is an output line of the first current sensor 411, an input terminal of the second amplifier 512 is connected to a second line 202, which is an output line of the second current sensor 412, and an input terminal of the third amplifier 512 is connected to a third line 203, which is an output line of the third current sensor 413.

The first amplifier 511 amplifies a first output signal 211 output from the first current sensor 411 and generates a first amplified output signal 221 through a first output line 271. In this case, the first amplified output signal 221 may have such a high magnitude as to be substantially not affected by external noises. The second amplifier 512 amplifies a second output signal 212 output from the second current sensor 412 and generates a second amplified output signal 222 through a second output line 272. Likewise, the second amplified output signal 222 may have a sufficiently high amplitude so as to be substantially not affected by external noises. Also, the third amplifier 513 amplifies a third output signal 213 output from the third current sensor 413 and generates a third amplified output signal 223, which may have a high enough amplitude so as to not be substantially affected by external noises, through a third output line 273.

If the first, second, and third output signals 211, 212, and 213 are sequentially input to the first, second, and third amplifiers 511, 512, and 513, respectively, as shown in FIG. 7A, the first, second, and third output signals 221, 222, and 223 are also sequentially output therefrom.

The first amplifier 511 is connected in parallel to a first variable resistor 521, which may be used to control the amplification gain of the first amplifier 511 by controlling the resistance of the first variable resistor 521. Likewise, the second and third amplifiers 512 and 513 are connected in parallel to a second variable resistor 522 and a third variable resistor 523, respectively.

FIG. 7B is a circuit diagram of an output signal amplifying unit 500b according to other embodiments of the present invention. The illustrated output signal amplifying unit 500b of the embodiments of FIG. 7B can be used when the pressure sensing unit 420 is used as the rotational direction sensing unit 400. The illustrated embodiments of the output signal amplifying unit 500b include a first amplifier 531 and a second amplifier 532. An input terminal of the first amplifier 531 is connected to a first line 241, which is an output line of the first pressure sensor 421, and an input terminal of the second amplifier 532 is connected to a second line 242, which is an output line of the second pressure sensor 422.

The first amplifier 531 amplifies a first output signal 251 output from the first pressure sensor 421 and generates a first amplified output signal 261 through a first output line 281. The second amplifier 542 amplifies a second output signal 252 output from the second pressure sensor 522 and generates a second amplified output signal 262 through a second output line 282. The first and second amplified output signals 261 and 262 may each have an amplitude sufficiently high so as not to be substantially affected by external noises. If the pressure measured at the outlet 372 is higher than that measured at the inlet 371, the intensity of the second output signal 252 of the second pressure sensor 422 is higher than that of the first output signal 251 of the first pressure sensor 421. As such, the amplitude of the second amplified output signal 262 is higher than that of the first amplified output signal 261. The first amplifier 531 is connected in parallel to a first variable resistor 541, which may be used to control the amplification gain of the first amplifier 531 by controlling the resistance of the variable resistor 541. Likewise, the second amplifier 532 is connected in parallel to the second variable resistor 542.

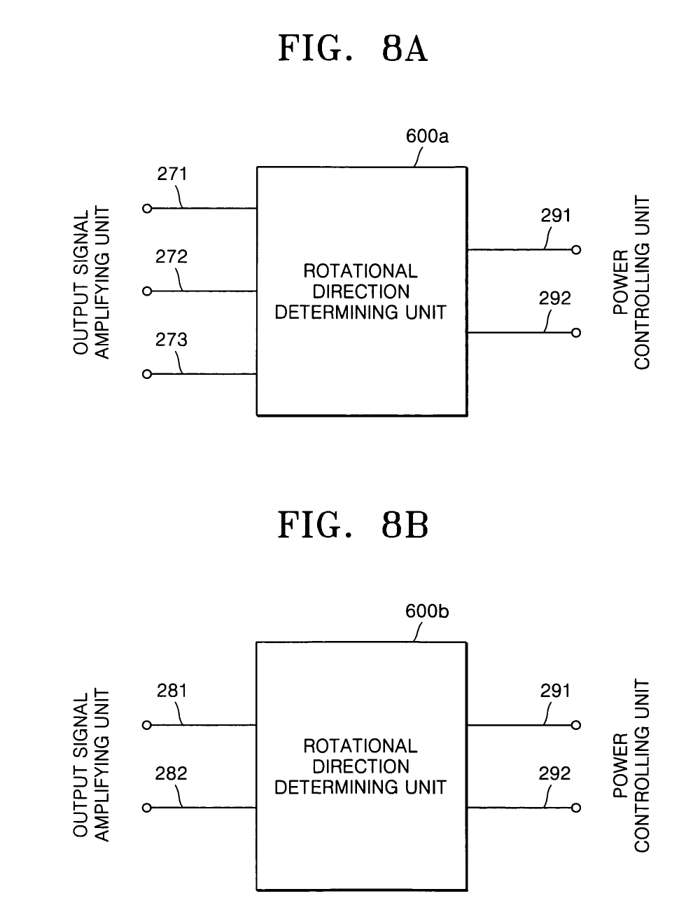

FIG. 8A is a schematic diagram illustrating the operation of a rotational direction determining unit 600a according to some embodiments of the present invention. The rotational direction determining unit 600a of the embodiments of FIG. 8A may be used when the current sensor 410 is used as the rotational direction sensing unit 400. The rotational direction determining unit 600a includes three input terminals and two output terminals. A first input terminal of the rotational direction determining unit 600a is connected to the first output line 271 of the output signal amplifying unit (500a of FIG. 7A), a second input terminal thereof is connected to the second output line 272 of the output signal amplifying unit 500a, and a third input terminal thereof is connected to the third output line 273 of the output signal amplifying unit 500a.

The rotational direction determining unit 600a determines a direction of rotation of the rotation unit 300 based on the timing sequence of the input of the first amplified output signal 211 transmitted by the first output line 271, the second amplified output signal 222 transmitted by the second output line 272, and the third amplified output signal 223 transmitted by the third output line 273. For example, in some embodiments of the present invention, if the first amplified output signal 221, the second amplified output signal 222, and the third amplified output signal 223 are sequentially transmitted to the rotational direction determining unit 600a as shown in FIG. 7A, it is determined that the direction of rotation of the rotation unit 300 is in a desired direction. If the first, second, and third amplified output signals 221, 222, and 223 are not sequentially transmitted to the rotational direction determining unit 600a in the sequence shown in FIG. 7A for such embodiments, it is determined that the rotation unit 300 is not rotating in the desired direction. When it is determined that the rotation unit 300 rotates in the desired direction, a first output signal is generated through the first output line 291. When it is determined that the rotation unit 300 does not rotate in the desired direction, the second output signal is generated through the second output line 292.

FIG. 8B is a schematic diagram that illustrates the operation of a rotational direction determining unit 600b according to other embodiments of the present invention wherein the rotational direction determining unit 600b is used with the pressure sensor 420 as the rotational direction determining unit 400. The illustrated embodiments of the rotational direction determining unit 600b include two input terminals and two output terminals. A first input terminal of the rotational direction determining unit 600b is connected to the first output line 281 of the output signal amplifying unit (500b of FIG. 7B), and a second input terminal thereof is connected to the second output line 282 of the output signal amplifying unit 500b.

The rotational direction determining unit 600b determines the rotational direction of the rotation unit 300 responsive to the amplitudes (intensities) of the first amplified output signal 261 transmitted by the first output line 281 and the second amplified output signal 262 transmitted by the second output line 282. For some embodiments of the present invention, when the pump (300b of FIG. 6) rotates in a desired direction, gas molecules are transported from the inlet 371 toward the outlet 372 and a pressure measured at the outlet 372 is higher than that measured at the inlet 371 (as illustrated by the signals 261, 262 in FIG. 7B). When the pump 300b rotates in an opposite direction, gas molecules are transported from the outlet 372 toward the inlet 371. In this condition, a pressure measured at the inlet 371 is higher than that measured at the outlet 372.

For example, when the intensity of the second amplified output signal 262 is higher than that of the first amplified output signal 261 as shown in FIG. 7B, a pressure measured at the outlet 372 is higher than that measured at the inlet 371. As a result, it is determined that the rotation unit 300 is rotating in the desired direction. However, when the amplitude of the second amplified output signal 262 is lower than that of the first amplified output signal 261, a pressure measured at the outlet 372 is lower than that measured at the inlet 371. As a result, it is determined that the rotation unit 300 is not rotating in the desired direction. If it is determined that the rotation unit 300 is rotating in the desired direction, the first output signal is generated on the first output line 291. If it is determined that the rotation unit 300 is not rotating in the desired direction, the second output signal is generated on the second output line 292.

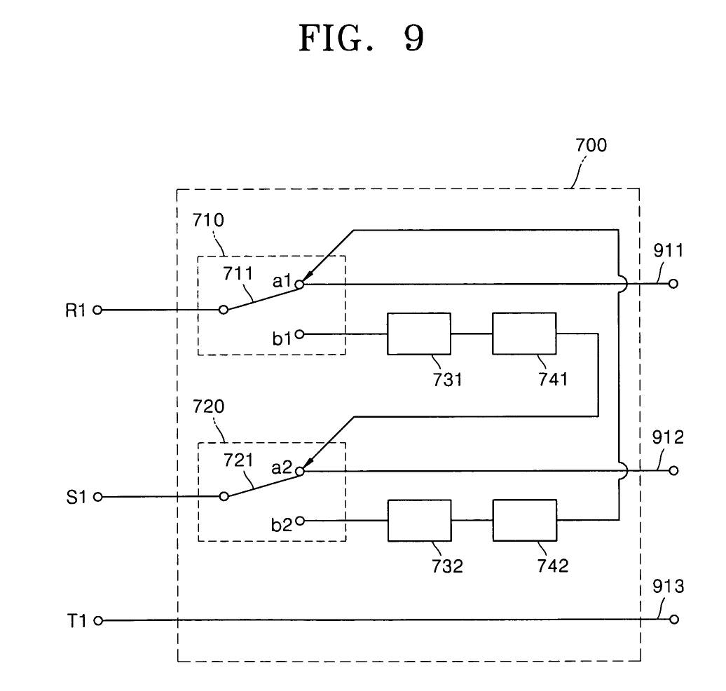

The above-described rotational direction determining unit 600a or 600b can be embodied using a typical logic circuit, for example, a programmable logic circuit (PLC). FIG. 9 is a circuit diagram illustrating some embodiments of the power controlling unit 700 shown in FIG. 3 wherein the power controlling unit 700 comprises a first and second switch circuit. As shown in the embodiments of FIG. 9, the power controlling unit 700 includes a first switching unit 710 and a second switching unit 720. The first switching unit 710 and the second switching unit 720 can be embodied using relays or typical switching circuits. For the illustrated embodiments, the first switching unit 710 includes a first switch 711, which is connected to a first power line R1 of the three-phase power lines, a first “a” contact a1, which is connected to a first power supply line 911 of the power supply lines via which power is supplied to the rotation unit 300, and a first “b” contact b1, which is connected to a second power supply line 912 of the power supply lines for the rotation unit 300.

The second switching unit 720 includes a first switch 721, which is connected to a second power line S1 of the three-phase power lines, a second “a” contact a2, which is connected to the first power supply line 911, and a second “b” contact b2, which is connected to the second power supply line 912. In addition, a third power line T1, which is another one of the three-phase power lines, is directly connected to a third power supply line 913 of the power supply lines via which power is supplied to the rotation unit 300.

The rotational direction of the rotation unit 300 can be reversed using the two switching units 710 and 720. This is possible because the rotational direction of the rotation unit 300 can be reversed by transposing at least one pair of the three-phase power lines R1, S1, and T1 and the first, second, and third power supply lines 911, 912, and 913 via which power is supplied to the rotation unit 300.

For some embodiments of the present invention, the operation of each of the first and second switches 711 and 721 depends on an output signal from the rotational direction determining unit (600a of FIG. 8A or 600b of FIG. 8B). For example, when the output signal of the rotational direction determining unit 600a or 600b is the first output signal, indicating that the rotation unit 300 is rotating in the desired direction, it is not necessary to reverse the rotational direction of the rotation unit 300. Thus, the first and second switches 711 and 721 remain connected to the first and second “a” contacts a1 and a2, respectively. However, if the output signal of the rotational direction determining unit 600a or 600b is the second output signal, indicating that the rotation unit 300 is not rotating in the desired direction, the rotational direction of the rotation unit 300 may be reversed. To do so, the first switch 711 and the second switch 721 may be switched such that they are separated from the first and second “a” contacts a1 and a2 and connected to the first and second “b” contacts b1 and b2, respectively. As a result, the first power line R1 is connected to the second power supply line 912 and the second power line S1 is connected to the first power supply line 911. This switch allows a reversal of the rotational direction of the rotation unit 300. Therefore, activation of the switch may be driven by the outputs of the rotational direction determining unit 600a, 600b.

Also shown in the illustrated embodiments of FIG. 9 are a first fuse 731 and a first delay 741 that are sequentially (serially) located between the first “b” contact b1 and the second “a” contact a2. A second fuse 732 and a second delay 742 are sequentially (serially) located between the second “b” contact b2 and the first “a” contact a1. The first and second fuses 731 and 732 may prevent a short from occurring in the first and second power lines R1 and S1 due to switching delays of the first and second switches 711 and 721. The first and second delays 741 and 742 may be used to interrupt providing of the reversed power supply until the rotation unit 300 stops.

As described above for some embodiments of the present invention, in the rotation system for the apparatus of manufacturing semiconductor devices, a transposition of three-phase power lines causes a reversal of a rotational direction of the rotation system. On sensing a rotational direction, it is determined whether the rotation system has a normal directional rotation or an opposite directional rotation. Based on the determination result, the routing (phase) of power supplied to the rotation system is controlled. Thus, the rotation system may be provided a desired normal directional rotation without manual re-wiring even if maintenance of the like has changed wiring of the rotation system.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1. A rotation control system for a rotation unit of an apparatus for manufacturing semiconductor devices, the system comprising:
an electrical power connection to the rotation unit; and
a control circuit configured to control the electrical power connection to the rotation unit to rotate the rotation unit in a desired direction responsive to a sensed rotational direction of the rotation unit.

2. The system of claim 1, wherein the electrical power connection comprises a three-phase electrical power connection having first, second and third power lines coupled to first, second and third power supply lines of the rotation unit and wherein the control circuit comprises a switch circuit having a first state in which the first power line is connected to the first power supply line and the second power line is connected to the second power supply line and a second state in which the first power line is connected to the second power supply line and the second power line is connected to the first power supply line.

3. The system of claim 2, wherein the switch circuit composes:
a first switch having an input coupled to the first power line, a first output coupled to the first power supply line and a second output coupled to the second power supply line; and
a second switch having an input coupled to the second power line, a first output coupled to the first power supply line and a second output coupled to the second power supply line.

4. The system of claim 3, wherein the switch circuit further comprises:
a first delay coupled between the second output of the first switch coupled to the second power supply line and the second power supply line;
a second delay coupled between the first output of the second switch coupled to the first power supply line and the first power supply line; and
wherein the first delay and the second delay are configured to interrupt power supply to the rotation unit until the rotation unit stops rotating.

5. The system of claim 1, wherein the sensed rotational direction is detected by a current sensing unit including a plurality of current sensors configured to sense a current associated with respective power lines associated with the electrical power connection and wherein the control circuit is configured to detect a sequence of output signals from respective ones of the current sensors to determine the sensed rotational direction of the rotation unit.

6. The system of claim 1, wherein the rotation unit comprises a pump having an inlet and an outlet and wherein the sensed rotational direction is detected by a first pressure sensor that detects a pressure at the inlet and a second pressure sensor that detects a pressure at the outlet and wherein the control circuit is configured to detect an amplitude difference between the first and second pressure sensor to determine the sensed rotational direction of the rotation unit.

7. A rotation system for an apparatus of manufacturing semiconductor devices including the rotation control system of claim 1, the rotation system further comprising:
the rotation unit;
a rotational direction sensing unit configured to generate a sense output signal based on a current rotational direction of the rotation unit; and
a rotational direction determining unit configured to generate the sense rotational direction responsive to the sense output signal of the rotational direction sensing unit.

8. A method of controlling a direction of rotation for a rotation unit of an apparatus for manufacturing semiconductor devices using a three-phase power supply having a plurality of power lines to power the rotation unit, the method comprising:
automatically sensing a current rotational direction of the rotation unit;
automatically determining whether the current rotational direction is a desired direction; and
automatically switching connections of the plurality of power lines to respective corresponding power supply lines of the rotation unit responsive to determining that the current rotational direction is not the desired direction.

9. A rotation system for an apparatus of manufacturing semiconductor devices, the system comprising:
a rotation unit;
a rotational direction sensing unit that senses an actual direction of rotation of the rotation unit and generates an output signal based on the sensing result;
a rotational direction determining unit that determines the actual direction of rotation of the rotation unit in response to the output signal of the rotational direction sensing unit; and
a power controlling unit that controls a power connection supplied to the rotation unit such that the rotation unit rotates in a desired direction based on the determined actual direction of rotation.

10. The system of claim 9, wherein the rotation unit includes at least one of a motor, of which a rotational direction is reversed by transposing three-phase power lines, or a pump including a rotor that is rotated by the motor.

11. The system of claim 10, wherein the rotational direction sensing unit includes at least three current sensors, which sense currents flowing through the respective three-phase power lines.

12. The system of claim 11, wherein the rotational direction determining unit determines a direction of rotation of the rotation unit depending on a sequence of input of three output signals output from the at least three current sensors and generates one of two output signals according to rotational directions, based on the determined actual direction of rotation.

13. The system of claim 10, wherein the rotational direction sensing unit includes at least two pressure sensors installed at an inlet and an outlet of the pump.

14. The system of claim 13, wherein the at least two pressure sensors measure pressures at the inlet and outlet, respectively, and generate output signals in proportion to the measured pressures.

15. The system of claim 14, wherein the rotational direction determining unit determines the rotational direction of the rotation unit by comparing the output signals of the two pressure sensors and generates one of two output signals according to rotational directions, based on the determined actual direction of rotation.

16. The system of claim 10, wherein the power controlling unit comprises:
a first switch circuit that selectively connects a first power line of the three-phase power lines to any one of a first power supply line and a second power supply line, through which power is supplied to the rotor that rotates by the motor; and
a second switch circuit that selectively connects a second power line of the three-phase power lines to any one of the first power supply line and the second power supply line, through which power is supplied to the rotor that rotates by the motor.

17. The system of claim 16, wherein the first switch circuit and the second switch circuit operate in response to the output signal of the rotational direction determining unit.

18. The system of claim 16, wherein the first switch circuit includes a switch connected to the first power line and a first contact and a second contact, which are connected to the first and second power supply lines, respectively, and wherein the second switch circuit includes a switch connected to the second power line and a third contact and a fourth contact, which are connected to the second and first power supply lines, respectively.

19. The system of claim 18, wherein the first switch circuit further comprises a first fuse and a first delay located between the second contact and the first contact, and wherein the second switch circuit further comprises a second fuse and a second delay located between the fourth contact and the first contact.

20. The system of claim 9, further comprising an output signal amplifying unit that amplifies the output signal of the rotational direction sensing unit and outputs the amplified output signal to the rotational direction determining unit.
